(19) United States
(12) Patent Application Publication
(10) Pub. No.: US 2013/0038517 A1
(43) Pub. Date: Feb. 14, 2013

(54) TFT PIXEL UNIT

(71) Applicant: Chihtsung Kang, Shenzhen (CN)

(72) Inventor: Chihtsung Kang, Shenzhen (CN)

(73) Assignee: Shenzhen China Star Optoeletronics Technology Co, LTD., Shenzhen (CN)

(21) Appl. No.: 13/376,594

(22) PCT Filed: Sep. 13, 2011
(86) PCT No.: PCT/CN11/79557

§ 371 Date: Dec. 7, 2011

(30) Foreign Application Priority Data
Aug. 8, 2011 (CN) 201110226020.7

(51) Int. Cl. G09G 3/36

(52) U.S. Cl. 345/92

(57) ABSTRACT

The present invention discloses a TFT pixel unit having a scan line, a first isolation layer, a data line, a source section, a semiconductor layer, a drain section and a pixel electrode. The first isolation layer is mounted on the scan line and covers an inner surface of the scan line. The data line and the scan line are isolatedly crossed with each other and define a pixel area. The drain section extends from a side of the data line and disposed on the first isolation layer. The semiconductor layer is mounted on a top surface of the drain section. The source section is mounted on a top surface of the semiconductor layer. The drain section, the semiconductor layer and the source section are adjacent to the inner surface of the scan line. The pixel electrode is mounted in the pixel area and connected to the source section. The date line, the drain section, the semiconductor layer and the source section construct a TFT switch having a vertically-stacked structure, which reduces the loss of aperture ratio.

### FIELD OF THE INVENTION

The present invention relates to a pixel unit of a liquid crystal panel, especially to a TFT pixel unit having a vertical structure.

### BACKGROUND OF THE INVENTION

With reference to FIG. 1, it is a schematic diagram of a structure of a conventional TFT (thin-film transistor) pixel unit. Generally speaking, the TFT pixel unit includes a scan line 90, a data line 91, a pixel electrode (not shown in the figure) and a switch unit 93, wherein the switch unit 93 has a gate 930, a semiconductor layer 931, a drain 932 and a source 933. The gate 930 is a portion of the scan line 90. The semiconductor layer 931 is disposed on the gate 930. The drain 932 extends from a side of the data line 91 and disposed on the semiconductor layer 931. The source 933 is disposed on the semiconductor layer 931 and connected to the pixel electrode. The gate 930 is applied with an appropriate voltage, which is capable of forming an electronic channel in the semiconductor layer 931 and then causing a conducting status between the drain 932 and the source 933 to accomplish a switch effect. In the meantime, the pixel electrode connected to the source 933 then is capable of being charged. With reference to FIG. 1, the drain 932 and the source 933 are disposed on a top surface of the semiconductor layer 931.

High-speed charging ability and high aperture ratio are generally the design requirements on pixel units for a TFT liquid crystal display device. As for a conventional technical skill, generally the charging ability of a pixel unit can be enhanced by reducing the channel width (shown as “C” in FIG. 1) or increasing the channel range between the source and the drain.

However, reducing the channel width usually requires specific masks cooperating with photo-resists, which is difficult to design for manufacturing. And increasing the channel range will cause a loss at aperture ratio and then lower light transmittance of the TFT liquid crystal display device.

Hence, it is necessary to provide a TFT pixel unit to overcome the problems existing in the conventional technology.

### SUMMARY OF THE INVENTION

In view of the shortcomings of the conventional technology, a primary object of the invention is to provide a TFT pixel unit which has a vertical TFT pixel structure to reduce the loss at aperture ratio.

In order to achieve foregoing object of the present invention, the present invention provides a TFT pixel unit comprising:

a scan line having an inner surface;

a first isolation layer mounted on the scan line and covering the inner surface;

a data line being isolatedly crossed with the scan line and defining a pixel area with the scan line;

a drain section extending from a side of the data line and disposed on the first isolation layer;

a semiconductor layer mounted on a top surface of the source section;

a source section mounted on a top surface of the semiconductor layer, and the drain section, the semiconductor layer and the source section are adjacent to the inner surface of the scan line; and

a pixel electrode mounted in the pixel area and connected to the source section.

In one embodiment of the present invention, a width of the source section is equal to a width of the semiconductor layer.

In one embodiment of the present invention, the TFT pixel unit further has a common-electrode line and a second electrode, and the common-electrode line is isolatedly disposed under the pixel electrode with the first isolation layer placed therebetween, parallel to the scan line and isolatedly crossed with the data line; and the second electrode is mounted on the first isolation layer in relation to the position of the common-electrode line, and is connected to the pixel electrode.

In one embodiment of the present invention, the TFT pixel unit further includes a second isolation layer, and the second isolation layer covers the source section, the semiconductor layer, the drain section and the second electrode and has a first through hole corresponding to the source section, and the pixel electrode is connected to the source section by means of the first through hole.

In one embodiment of the present invention, the second isolation layer further has a second through hole corresponding to the second electrode, and the pixel unit is connected to the second electrode by means of the second through hole.

In one embodiment of the present invention, the semiconductor layer includes an amorphous silicon layer and an N-type amorphous silicon layer.

The present invention mainly makes the data line, the drain section, the semiconductor layer and the source section to be configured into a TFT switch having a vertical stacked structure, and thereby reduces the loss at aperture ratio.

### DESCRIPTION OF THE DRAWINGS

FIG. 1 is a schematic diagram of a partial plan view of a conventional TFT pixel unit;

FIG. 2 is a schematic diagram of a partial plan view of a preferred embodiment of a TFT pixel unit in accordance with the present invention; and

FIG. 3 is a schematic diagram of a cross-sectional view taken along a line A-A′ in FIG. 2.

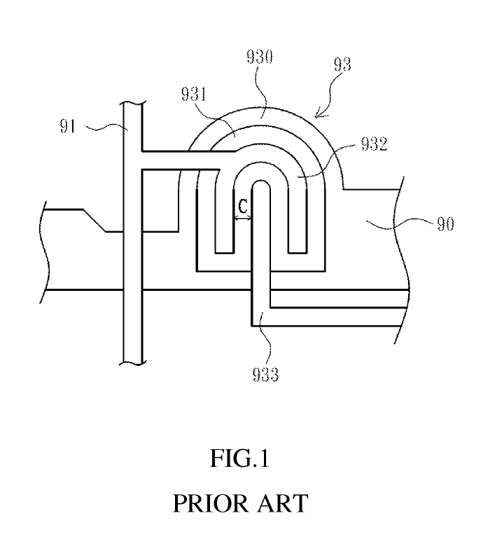

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

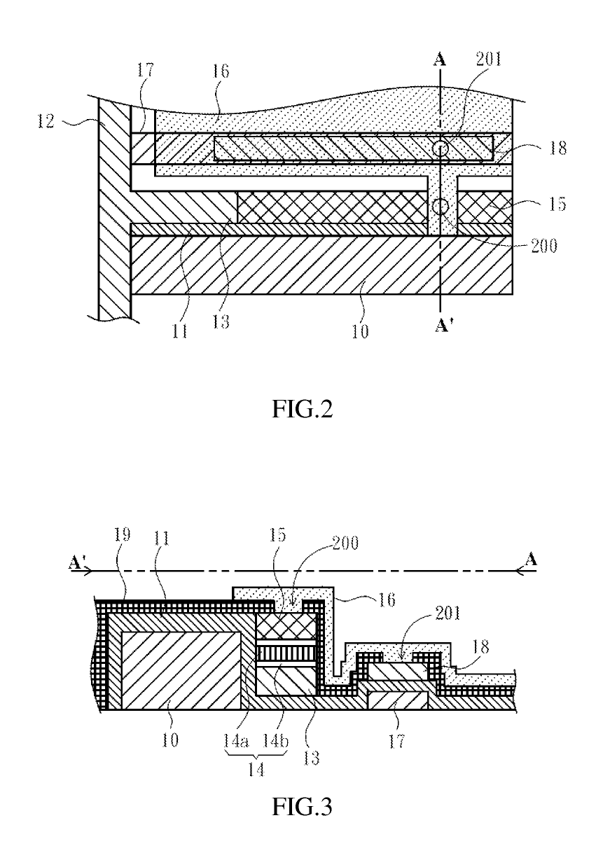

With reference to FIG. 2 and FIG. 3, FIG. 2 and FIG. 3 are respectively a partial plan view and a cross-sectional view of a preferred embodiment of a TFT pixel unit in accordance with the present invention. The TFT pixel unit of the present invention is applied to a thin-film-transistor liquid crystal display device, and comprises a scan line 10, a first isolation layer 11, a data line 12, a drain section 13, a semiconductor layer 14, a source section 15 and a pixel electrode 16.

The scan line 10 is made of electric conductive materials and has an inner surface 100.

The first isolation layer 11 is mounted on the scan line 10 by means of deposition and covers the inner surface 100. The first isolation layer 11 is preferably a SiNx film or a SiOx film.

The data line 12 and the scan line 10 are isolatedly crossed with each other with the first isolation layer 11 placed therebetween, and the data line 12 and the scan line 10 together define a pixel area.

The drain section 13 extends from a side of the data line 12 and disposed on the first isolation layer 11. In more details, the drain section 13 extends along a direction parallel to the scan line 10 and is adjacent to the inner surface 100 of the scan line 10 with the first isolation layer 11 placed therebetween.

The semiconductor layer 14 is disposed on a top surface of the drain section 13. Similarly, the semiconductor layer 14 extends along a direction parallel to the scan line 10 and is adjacent to the inner surface 100 of the scan line 10 with the first isolation layer 11 placed therebetween. The semiconductor layer 14 preferably includes an amorphous slicon (a-Si) layer 14a and an N-type amorphous silicon layer 14b.

The source section 15 is disposed on a top surface of the semiconductor layer 14. Similarly, the source section 15 extends along the direction parallel to the scan line 10 and is adjacent to the inner surface 100 of the scan line 10 with the first isolation layer 11 placed therebetween. A width of the source section 15 is preferably equal to a width of the semiconductor layer 14.

The pixel electrode 16 is mounted in the pixel area and connected to the source section 15.

In this embodiment, the TFT pixel unit of the present invention further comprises a common-electrode line 17, a second electrode 18 and a second isolation layer 19.

The common-electrode line 17 is isolatedly disposed under the pixel electrode 16 with the first isolation layer 11 placed therebetween, and is parallel to the scan line 10 and also crossed isolatedly with the data line 12.

The second electrode 18 is mounted on the first isolation layer 11 in relation to the position of the common-electrode line 17, and connected to the pixel electrode 16. The second electrode 18 and the common-electrode line 17 construct a storage capacitor that is capable of storing a pixel voltage.

The second isolation layer 19 covers the drain section 13, the semiconductor layer 14, the source section 15 and the second electrode 18. Furthermore, the second isolation layer 19 has a first through hole 200 corresponding to the source section 15, such that the pixel electrode 16 can be connected to the source section 15 by means of the first through hole 200. The second isolation layer 19 further has a second through hole 201 corresponding to the second electrode 18, such that the pixel electrode 16 can be connected to the second electrode 18 by means of the second through hole 201.

In the TFT pixel unit of the present invention, the stacked structure constructed by the drain section 13, the semiconductor layer 14 and the source section 15 forms a vertically-stacked TFT-switch configuration relatively to the scan line 10 with the first isolation layer 11 placed therebetween, wherein the scan line is the gate terminal. When the scan line 10 receives an appropriate voltage, the semiconductor layer 14 then is able to form an electronic channel between the drain section 13 and the source section 15. And the semiconductor layer 14 can be accomplished with a desired thickness by means of deposition to have a high-current charging ability with small-channel.

In conclusion, comparing with the conventional TFT pixel unit that the source thereof is disposed on the top surface of its semiconductor layer, the drain section 13, the semiconductor layer 14 and the source section 15 of the TFT pixel unit of the present invention construct a vertically stacked TFT-switch configuration, which relatively reduces loss of aperture ratio and further contributes to enhance image quality of a liquid crystal display device.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A TFT pixel unit, characterized in that: the TFT pixel unit comprises:
a scan line having an inner surface;
a first isolation layer mounted on the scan line and covering the inner surface;
a data line being isolatedly crossed with the scan line and defining a pixel area with the scan line;
a drain section extending from a side of the data line and disposed on the first isolation layer;
a semiconductor layer mounted on a top surface of the source section;
a source section mounted on a top surface of the semiconductor layer, and the drain section, the semiconductor layer and the source section are adjacent to the inner surface of the scan line, and a width of the source section is equal to a width of the semiconductor layer; and
a pixel electrode mounted in the pixel area and connected to the source section;
a common-electrode line isolatedly mounted under the pixel electrode with the first isolation layer placed therebetween, being parallel to the scan line and isolatedly crossed with the data line; and
a second electrode mounted on the first isolation layer in relation to the position of the common-electrode line and connected to the pixel electrode.

2. A TFT pixel unit, characterized in that: the TFT pixel unit comprises:
a scan line having an inner surface;
a first isolation layer mounted on the scan line and covering the inner surface;
a data line being isolatedly crossed with the scan line and defining a pixel area with the scan line;
a drain section extending from a side of the data line and disposed on the first isolation layer;
a semiconductor layer mounted on a top surface of the source section;
a source section mounted on a top surface of the semiconductor layer, and the drain section, the semiconductor layer and the source section are adjacent to the inner surface of the scan line; and
a pixel electrode mounted in the pixel area and connected to the source section.

3. The TFT pixel unit as claimed in claim 2, characterized in that: a width of the source section is equal to a width of the semiconductor layer.

4. The TFT pixel unit as claimed in claim 2, characterized in that: the TFT pixel unit further comprises a common-electrode line and a second electrode, and the common-electrode line is isolatedly disposed under the pixel electrode with the first isolation layer placed therebetween, parallel to the scan line and isolatedly crossed with the data line; and the second electrode is mounted on the first isolation layer in relation to the position of the common-electrode line, and is connected to the pixel electrode.

5. The TFT pixel unit as claimed in claim 4, characterized in that: the TFT pixel unit further includes a second isolation layer, and the second isolation layer covers the drain section, the semiconductor layer, the source section and the second electrode and has a first through hole corresponding to the source section, and the pixel electrode is connected to the source section by means of the first through hole.

6. The TFT pixel unit as claimed in claim 5, characterized in that: the second isolation layer further has a second through hole corresponding to the second electrode, and the pixel unit is connected to the second electrode by means of the second through hole.

7. The TFT pixel unit as claimed in claim 2, characterized in that: the semiconductor layer includes an amorphous silicon layer and an N-type amorphous silicon layer.
